(19) United States
(12) Patent Application Publication
(10) Pub. No.: US 2014/0203974 A1
(43) Pub. Date: Jul. 24, 2014

(54) ELECTRONIC DEVICE AND ANTENNA UNIT THEREOF

(71) Applicants: Shih-Ping Liu, Taipei City (TW); Hao-Ran Lee, Taipei City (TW); Chung-Ta Yu, Taipei City (TW); Mei-Hsiung Tsai, Taipei City (TW); Yi-Min Yu, Taipei City (TW)

(72) Inventors: Shih-Ping Liu, Taipei City (TW); Hao-Ran Lee, Taipei City (TW); Chung-Ta Yu, Taipei City (TW); Mei-Hsiung Tsai, Taipei City (TW); Yi-Min Yu, Taipei City (TW)

(73) Assignee: COMPAL ELECTRONICS, INC., Taipei City (TW)

(21) Appl. No.: 13/792,217

(22) Filed: Mar. 11, 2013

(30) Foreign Application Priority Data
Jan. 23, 2013 (TW) 102102499

(51) Int. Cl. H01Q 13/10

(52) U.S. Cl. CPC H01Q 13/10
USPC 343/702; 343/770

(57) ABSTRACT

An electronic device includes a body and an antenna unit. The body has a casing, in which the casing includes a back cover and a first side-wall. The antenna unit disposed in the casing is adjacent to the first side-wall and has a plurality of slots, in which the antenna unit includes a first conductor, a second conductor and a third conductor. The first conductor faces the first side-wall. The second conductor is bent connected to a side-edge of the first conductor to face the back cover and grounded to the back cover. The third conductor is bent connected to the other side-edge of the first conductor, in which the slots are formed on at least one of the first conductor and the third conductor.

### CROSS-REFERENCE TO RELATED APPLICATION

This application claims the priority benefit of Taiwan application serial no. 102102499, filed on Jan. 23, 2013. The entirety of the above-mentioned patent application is hereby incorporated by reference herein and made a part of this specification.

### BACKGROUND OF THE INVENTION

1. Field of the Invention

The invention generally relates to an electronic device and an antenna unit thereof, and more particularly, to an electronic device and an antenna unit with slots.

2. Description of Related Art

With advances in technology, mass communication has been gradually changed to wireless communications such as smart phone, tablet PC with wireless Internet access function and notebook computer, etc., all which belong to the scope of the wireless communication. The wireless communication normally needs an antenna to transmit and receive the message.

Under the situation of increasingly slim design of the electronic device, if an electronic device has a metallic casing, the antenna is hard to be disposed far away from the metallic casing due to a limited layout space. As a result, the signal of the antenna would be interfered by the metallic casing. For example, the antennas of many notebook computers are disposed at the display screen with a metallic casing. In order to avoid the antenna is too close to the metallic casing to affect the reception/transmission of signals, it is needed to employ a non-metallic casing, instead of a metallic casing, disposed at a position of the display screen corresponding to the antenna, which however would increase the fabrication cost and affect the appearance of the notebook computer. In addition, some of the notebook computers have a slot formed on the metallic casing of the display screen to constitute a slot antenna, which would affect appearance of the notebook computer and increase the process complexity thereof as well.

### SUMMARY OF THE INVENTION

Accordingly, the invention is directed to an electronic device, in which the antenna unit thereof is able to make the electronic device have better appearance.

The invention is also directed to an antenna unit enable the electronic device to have better appearance.

An electronic device of the invention includes a body and an antenna unit. The body has a casing, in which the casing includes a back cover and a first side-wall. The antenna unit disposed in the casing is adjacent to the first side-wall and has a plurality of slots, in which the antenna unit includes a first conductor, a second conductor and a third conductor. The first conductor faces the first side-wall. The second conductor is bent connected to a side-edge of the first conductor to face the back cover and grounded to the back cover. The third conductor is bent connected to the other side-edge of the first conductor, in which the slots are formed on at least one of the first conductor and the third conductor.

The antenna unit of the invention has a plurality of slots and includes a first conductor, a second conductor and a third conductor. The second conductor is bent connected to a side-edge of the first conductor and the third conductor is bent connected to the other side-edge of the first conductor, in which the slots are formed on at least one of the first conductor and the third conductor.

In an embodiment of the invention, the antenna unit is integrally formed.

In an embodiment of the invention, the first conductor, the second conductor and the third conductor form a U-shaped structure.

In an embodiment of the invention, the casing further includes a front frame, the third conductor faces the front frame, and the second conductor and the third conductor respectively lean against the back cover and the front frame to fix the antenna unit between the back cover and the front frame.

In an embodiment of the invention, the material of the back cover includes metallic material.

In an embodiment of the invention, the slots include a first slot and a second slot, in which the length of the first slot is equal to a half of the wavelength of a first resonant frequency and the length of the second slot is equal to a half of the wavelength of a second resonant frequency.

In an embodiment of the invention, the first slot or the second slot extends to the third conductor from the first conductor.

In an embodiment of the invention, the slots further include a third slot, the third slot extends to the edge of the first conductor or the edge of the third conductor to form an opening.

In an embodiment of the invention, the antenna unit further includes a fourth conductor, the fourth conductor is connected to an end of the first conductor and vertical to the first conductor, and the first slot or the second slot extends to the fourth conductor from the first conductor.

In an embodiment of the invention, the casing further includes a second side-wall, the second side-wall is connected to an end of the first side-wall and vertical to the first side-wall, and the fourth conductor is adjacent to the second side-wall.

In an embodiment of the invention, at least two of the slots extend to the edge of the first conductor to form a plurality of openings.

In an embodiment of the invention, the antenna unit has feeding points, the feeding points are disposed at the first conductor or the third conductor.

Based on the description above, the antenna unit of the invention is disposed in the casing of the electronic device and adjacent to the first side-wall of the casing. The second conductor of the antenna unit faces the back cover of the casing so that the slots on the first conductor or the third conductor of the antenna unit do not face the back cover. Therefore, even the material of the back cover is metal and conductive, the signals received and transmitted by the antenna unit through the slots thereof are less affected by the interference of the back cover and the signal receiving/transmitting capacity of the antenna unit is advanced. In this way, there is no need to employ a non-metallic shell disposed on the back cover at a position corresponding to the antenna unit for avoiding the interference of the back cover on the antenna unit, which further reduces manufacture cost and enables the electronic device to have better appearance.

In order to make the features and advantages of the present invention more comprehensible, the present invention is further described in detail in the following with reference to the embodiments and the accompanying drawings.

### BRIEF DESCRIPTION OF THE DRAWINGS

FIG. 1 is a three-dimensional diagram of an electronic device in an embodiment of the invention.

FIG. 2 is an exploded diagram of partial parts of the electronic device of FIG. 1.

FIG. 3 is a partial three-dimensional diagram of the electronic device of FIG. 2.

FIG. 4 is a partial three-dimensional diagram of the electronic device of FIG. 3.

FIG. 5 is a partial three-dimensional diagram of the electronic device of FIG. 1.

FIG. 6 is a schematic diagram showing an insulating cover-body covers the notch of FIG. 3.

FIG. 7 is a partial three-dimensional diagram of an electronic device according to another embodiment of the invention.

FIG. 8 is a partial three-dimensional diagram of an electronic device according to yet another embodiment of the invention.

FIG. 9 is a partial three-dimensional diagram of an electronic device according to yet another embodiment of the invention.

FIG. 10 is a plot of a return loss curve of the antenna unit of FIG. 9.

FIG. 11 is a plot of the radiation pattern on XY plane of the antenna unit of FIG. 9 at operating frequency band of 2.4-2.5 GHz.

FIG. 12 is a plot of the radiation pattern on XY plane of the antenna unit of FIG. 9 at operating frequency band of 5.15-5.85 GHz.

FIG. 13 is a partial three-dimensional diagram of an electronic device according to yet another embodiment of the invention.

FIG. 14 is a three-dimensional diagram of the antenna unit of FIG. 13.

FIG. 15 is a partial three-dimensional diagram of an electronic device according to yet another embodiment of the invention.

FIG. 16 is a three-dimensional diagram of some parts of an electronic device according to yet another embodiment of the invention.

### DESCRIPTION OF THE EMBODIMENTS

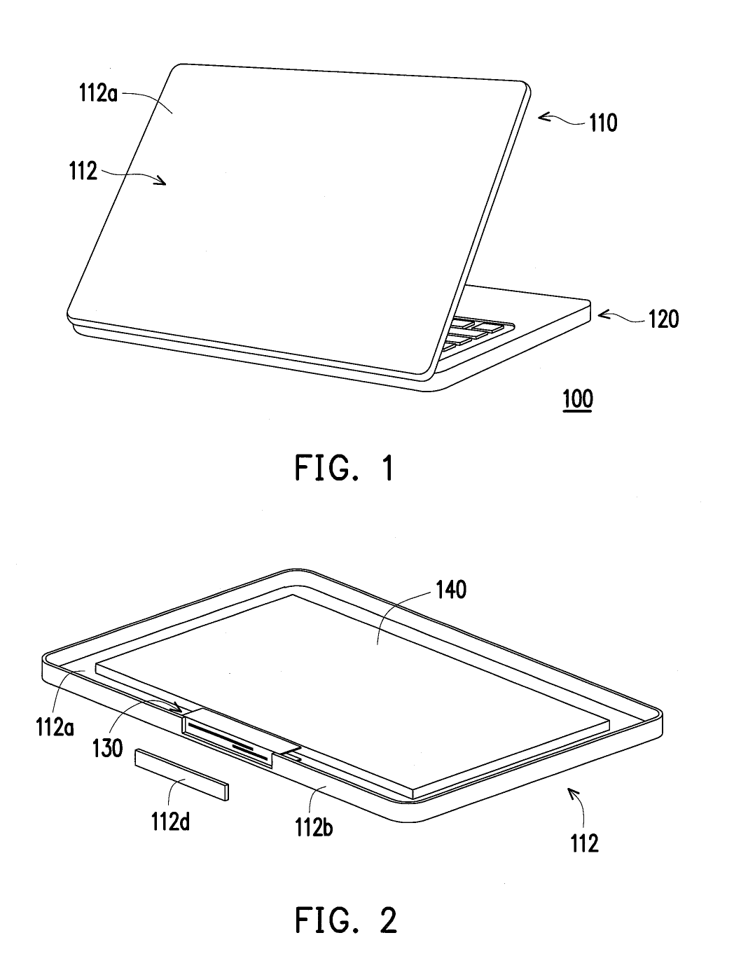

FIG. 1 is a three-dimensional diagram of an electronic device in an embodiment of the invention. Referring to FIG. 1, an electronic device 100 of the embodiment is, for example, a notebook computer and includes two bodies 110 and 120. The bodies 110 and 120 are, for example, respectively a display screen and a base of the notebook computer. In other embodiments, the electronic device 100 can be electronic devices of other kinds, which the invention is not limited to.

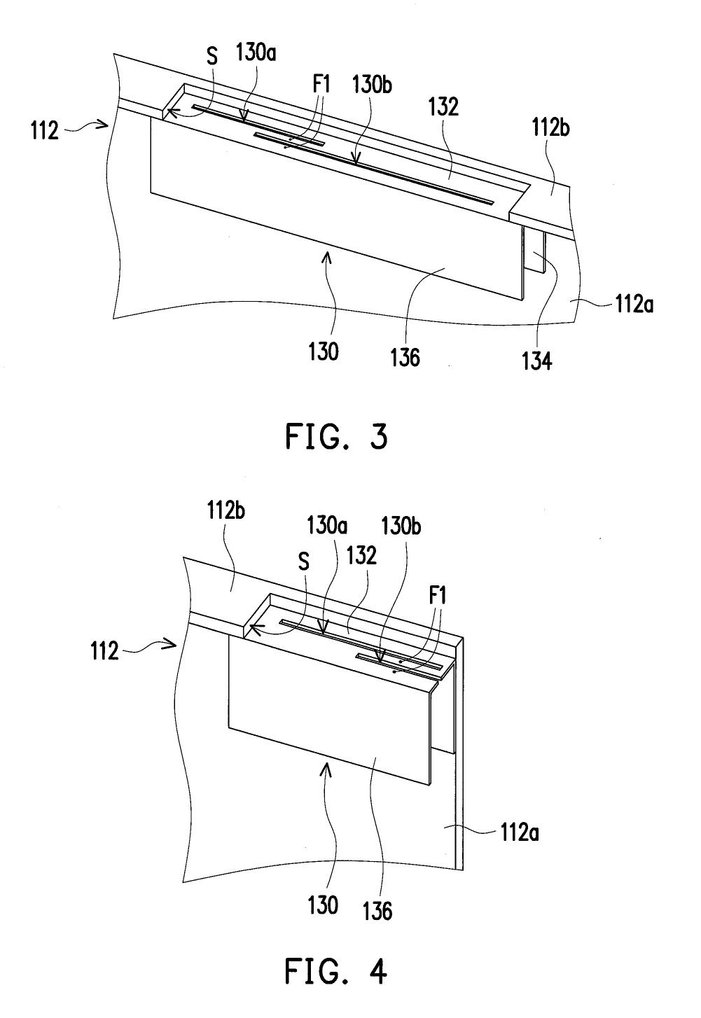

FIG. 2 is an exploded diagram of partial parts of the electronic device of FIG. 1, FIG. 3 is a partial three-dimensional diagram of the electronic device of FIG. 2 and FIG. 4 is a partial three-dimensional diagram of the electronic device of FIG. 3. Referring to FIGS. 2-4, the body 110 has a casing 112, in which the casing 112 includes a back cover 112a and a first side-wall 112b. The material of the back cover 112a is, for example, metallic material. The electronic device 100 further includes an antenna unit 130 disposed in the casing 112, located at a side of a display panel 140 and adjacent to the first side-wall 112b. The antenna unit 130 has a plurality of slots (first slot 130a and second slot 130b are shown in figures) to constitute a slot antenna, in which the length of the first slot 130a is equal to a half of the wavelength of a first resonant frequency and the length of the second slot 130b is equal to a half of the wavelength of a second resonant frequency. In this way, the antenna unit 130 is able to respectively use the first slot 130a and the second slot 130b for receiving and transmitting the signals operating at the first frequency band and the second frequency band.

In more details, the antenna unit 130 includes a first conductor 132, a second conductor 134 and a third conductor 136. The first conductor 132 faces the first side-wall 112b; the second conductor 134 is bent connected to a side-edge of the first conductor 132 to face the back cover 112a; the third conductor 136 is bent connected to the other side-edge of the first conductor 132. The first slot 130a and the second slot 130b are formed, for example, on at least one of the first conductor 132 and the third conductor 136. In the embodiment, the first slot 130a and the second slot 130b, as shown in figures, are formed at the first conductor 132.

With the above-mentioned layout, the antenna unit 130 is disposed in the casing 112 of the electronic device 100 and adjacent to the first side-wall 112b of the casing 112. At the time, the antenna unit 130 uses the second conductor 134 thereof to face the back cover 112a of the casing 112 to make the first slot 130a and the second slot 130b on the first conductor 132 of the antenna unit 130 do not face the back cover 112a. Thereby, even when the material of the back cover 112a is metal and conductive, the interference of the back cover 112a on the signals received and transmitted by the antenna unit 130 through the first slot 130a and the second slot 130b can be reduced and the signal receiving/transmitting capacity of the antenna unit 130 is advanced. In this way, there is no need to employ a non-metallic shell disposed on the back cover 112a at a position corresponding to the antenna unit 130 for avoiding the interference of the back cover 112a on the antenna unit 130, which enables the electronic device 100 to have better appearance. Additionally, the antenna unit 130 gains good signal receiving/transmitting capacity due to the above-mentioned layout, there is no need to form slots at the back cover 112a for receiving/transmitting signals as well, which enables the back cover 112a to have better appearance and reduces the process complexity of the back cover 112a.

In the embodiment, the antenna unit 130 uses the second conductor 134 thereof facing the back cover 112a to be grounded to the back cover 112a. In addition, the antenna unit 130 has feeding points F1 disposed at the first conductor 132, one terminal in F1 is signal input and the other is ground, and are connected to a feed line such as a coaxial cable to feed-in signals by welding or other appropriate methods. Other differential feeding methods are applicable and not addressed too much in the invention.

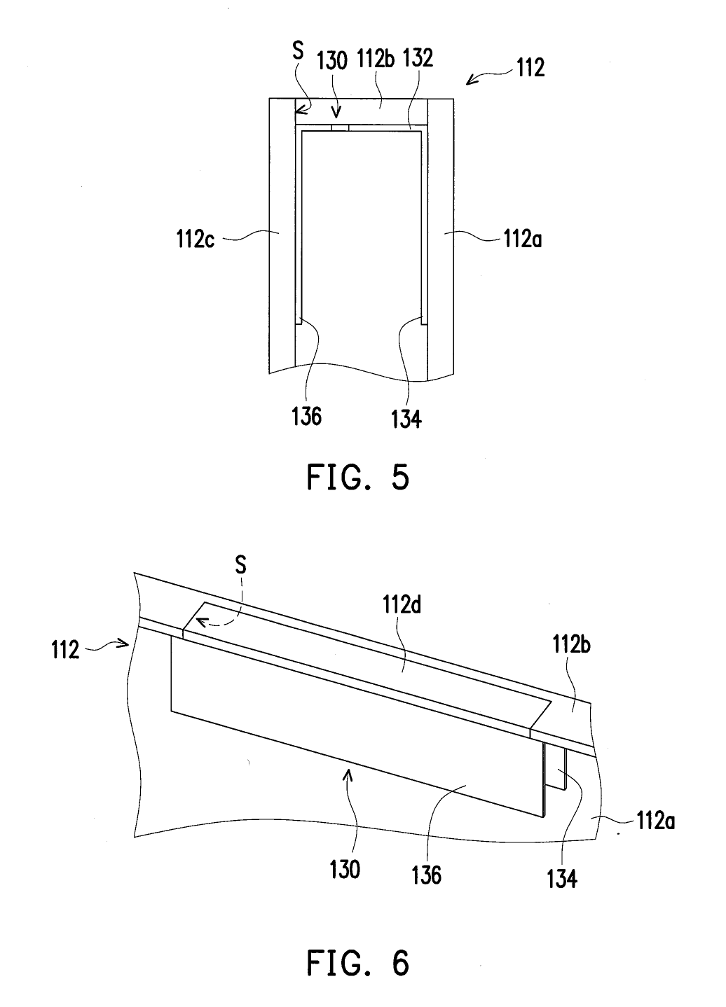

FIG. 5 is a partial three-dimensional diagram of the electronic device of FIG. 1. Referring to FIGS. 4 and 5, the antenna unit 130 in the embodiment, for example by bending the metal conductor, forms a U-shaped integrally formed structure. The casing 112 further includes a front frame 112c, the third conductor 136 facing the front frame 112c, and the second conductor 134 and the third conductor 136 respectively lean against the back cover 112a and the front frame 112c so as to fix the antenna unit 130 between the back cover 112a and the front frame 112c in embedding way. The second conductor 134 and the third conductor 136 can be respectively adhered to the back cover 112a and the front frame 112c so as to firmly fix the antenna unit 130.

In the embodiment, the material of the first side-wall 112b is, for example, metallic material and has a notch S. The first conductor 132 is at a position corresponding to the notch S to reduce the interference extent of the first side-wall 112b with conductivity on the receiving/transmitting signals of the antenna unit 130 through the first slot 130a and the second slot 130b. FIG. 6 is a schematic diagram showing an insulating cover-body covers the notch of FIG. 3. In the embodiment, the casing 112, as shown by FIGS. 2 and 6, can further include an insulating cover-body 112d. The insulating cover-body 112d covers the notch S to avoid the antenna unit 130 from being exposed. Since the notch S and the insulating cover-body 112d in the embodiment are located at the first side-wall 112b of the casing 112, not at the back cover 112a, they do not affect the nice-look of the back cover 112a of the electronic device 100. In other embodiments, the material of the first side-wall can be insulating material, be without notch and directly cover the antenna unit.

The invention does not limit the form, the positions and the extending ranch of the slots of the antenna unit, referring to the examples in association with the figures in following.

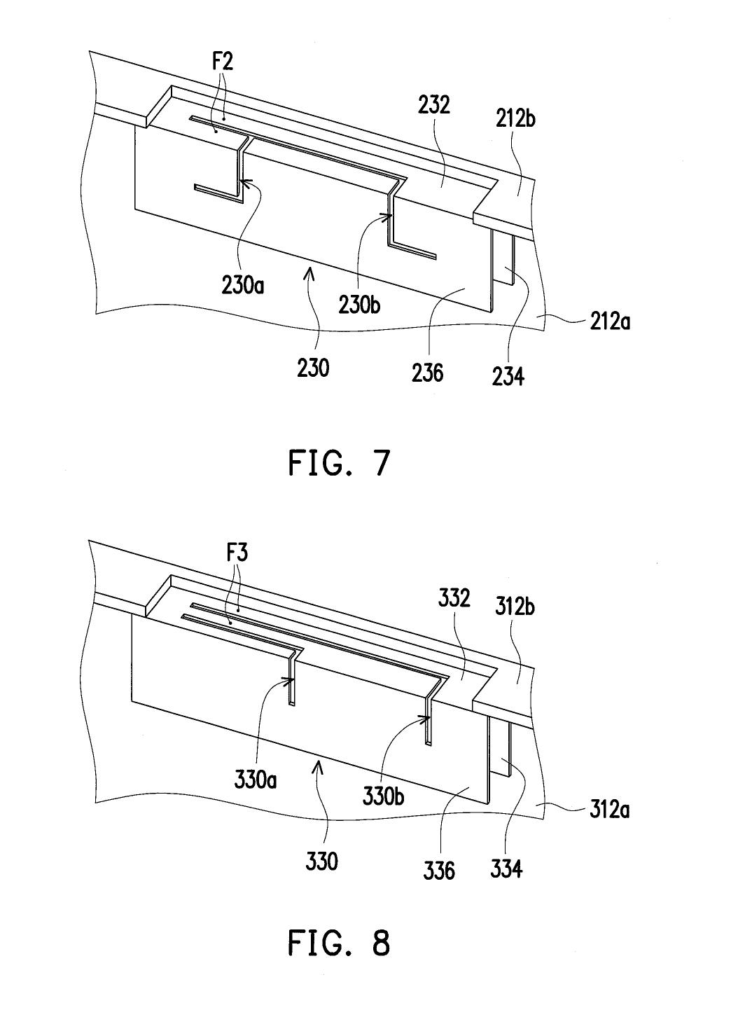

FIG. 7 is a partial three-dimensional diagram of an electronic device according to another embodiment of the invention. Referring to FIG. 7, in the embodiment, the layout of a back cover 212a, a first side-wall 212b, a first conductor 232, a second conductor 234, a third conductor 236 and feeding points F2 is similar to the layout of the back cover 112a, the first side-wall 112b, the first conductor 132, the second conductor 134, the third conductor 136 and the feeding points F1 in FIG. 3, which is omitted to describe. The major difference of the antenna unit 230 in the embodiment from the antenna unit 130 of FIG. 3 rests in that the first slot 130a and the second slot 130b of the antenna unit 130 in FIG. 3 are not extended to the third conductor 136, while the first slot 230a and the second slot 230b of the antenna unit 230 in the embodiment are extended to the third conductor 236 from the first conductor 232.

FIG. 8 is a partial three-dimensional diagram of an electronic device according to yet another embodiment of the invention. Referring to FIG. 8, in the embodiment, the layout of a back cover 312a, a first side-wall 312b, a first conductor 332, a second conductor 334, a third conductor 336 and feeding points F3 is similar to the layout of the back cover 212a, the first side-wall 212b, the first conductor 232, the second conductor 234, the third conductor 236 and the feeding points F2 in FIG. 7, which is omitted to describe. The major difference of the antenna unit 330 in the embodiment from the antenna unit 230 of FIG. 7 rests in that the first slot 230a and the second slot 230b of the antenna unit 230 in FIG. 7 are connected to each other and use the same feed points, while the first slot 330a and the second slot 330b of the antenna unit 330 of the embodiment are not connected to each other, and the feed points F3 are used for exciting the second slot 330b and the first slot 330a is then coupled by the second slot 330b.

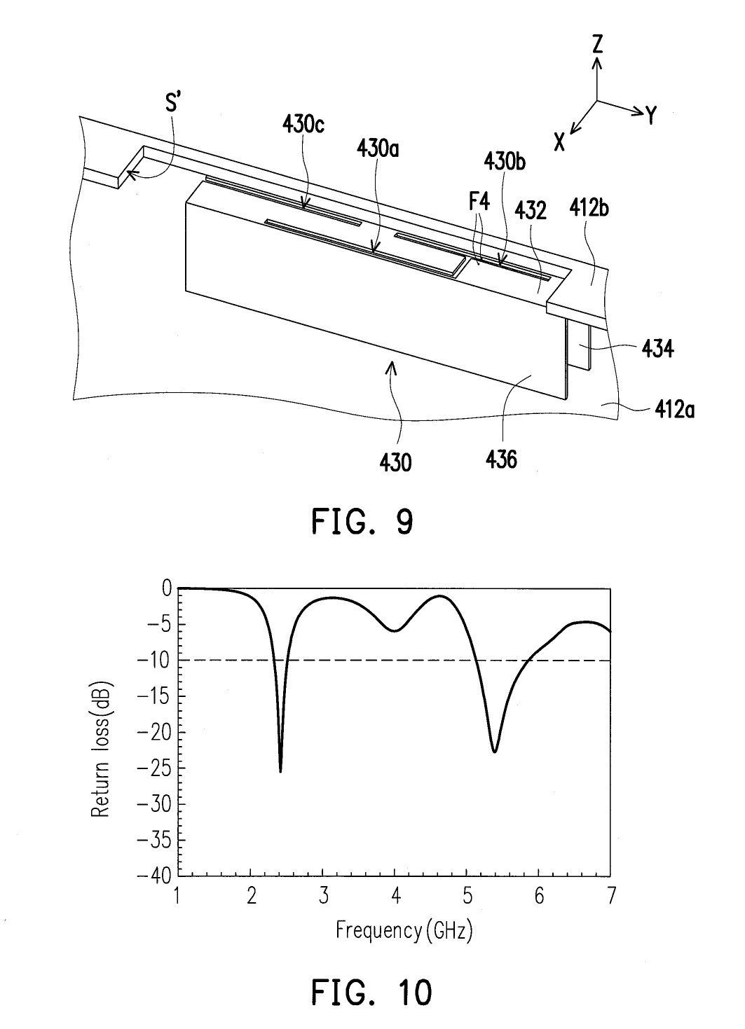

FIG. 9 is a partial three-dimensional diagram of an electronic device according to yet another embodiment of the invention. Referring to FIG. 9, the layout of a back cover 412a, a first side-wall 412b, a first conductor 432, a second conductor 434, a third conductor 436 and feeding points F4 in the embodiment is similar to the layout of the back cover 112a, the first side-wall 112b, the first conductor 132, the second conductor 134, the third conductor 136 and the feeding points F1 in FIG. 3, which is omitted to describe. The major difference of the antenna unit 430 in the embodiment from the antenna unit 130 of FIG. 3 rests in that in addition to having a first slot 430a and a second slot 430b, the antenna unit 430 in FIG. 9 further has a third slot 430c. The third slot 430c extends to the edge of the first conductor 432 to form an opening, which makes the third slot 430c constitute a coupled capacitive load to increase the operation bandwidth of the first slot 430a of the antenna unit 430.

FIG. 10 is a plot of a return loss curve of the antenna unit of FIG. 9. It can be seen from the return loss curve in FIG. 10 that, by using the above-mentioned coupled capacitive load to increase the bandwidth of the antenna unit 430, the operating bandwidth of the antenna unit 430 can cover the operating frequency band (2.4-2.5 GHz) required by the wireless local area network (WLAN).

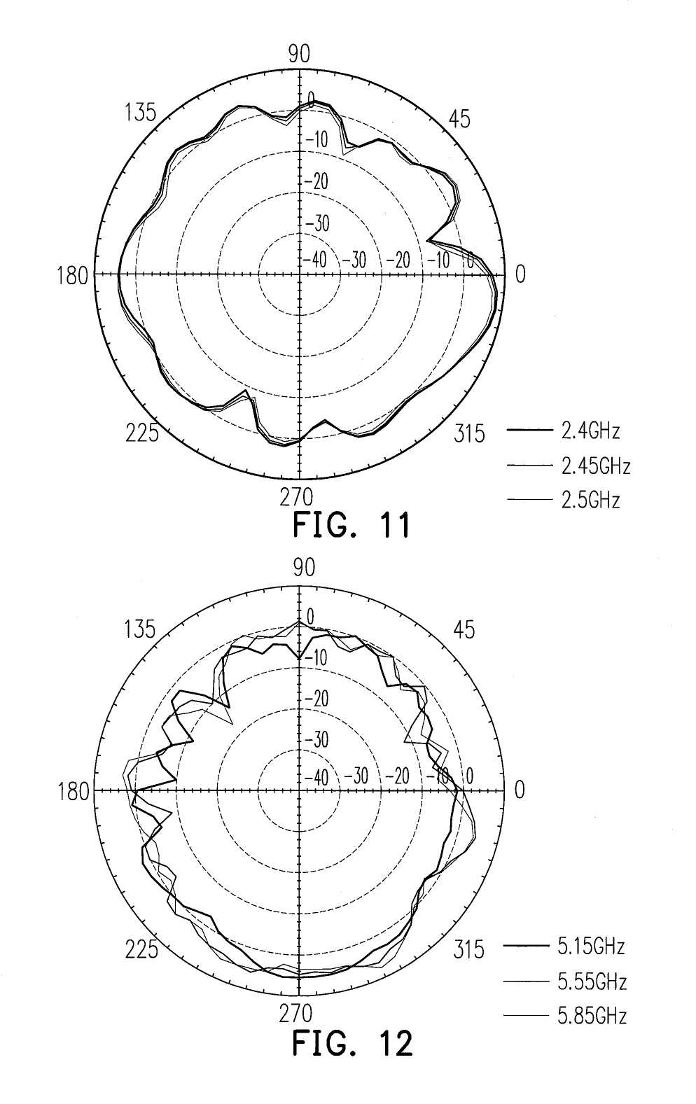

FIG. 11 is a plot of the radiation pattern on XY plane of the antenna unit of FIG. 9 at operating frequency band of 2.4-2.5 GHz and FIG. 12 is a plot of the radiation pattern on XY plane of the antenna unit of FIG. 9 at operating frequency band of 5.15-5.85 GHz. In FIGS. 11 and 12, the unit of the radiation pattern is gain (dB), where the figures on the circle indicate the azimuth degrees. As shown by FIGS. 11 and 12, under the above-mentioned layout, the radiation patterns of the antenna unit 430 on XY plane at operating frequency bands of 2.4-2.5 GHz and 5.15-5.85 GHz are approximated to omnidirectional radiation and have a good signal transmission/reception capability.

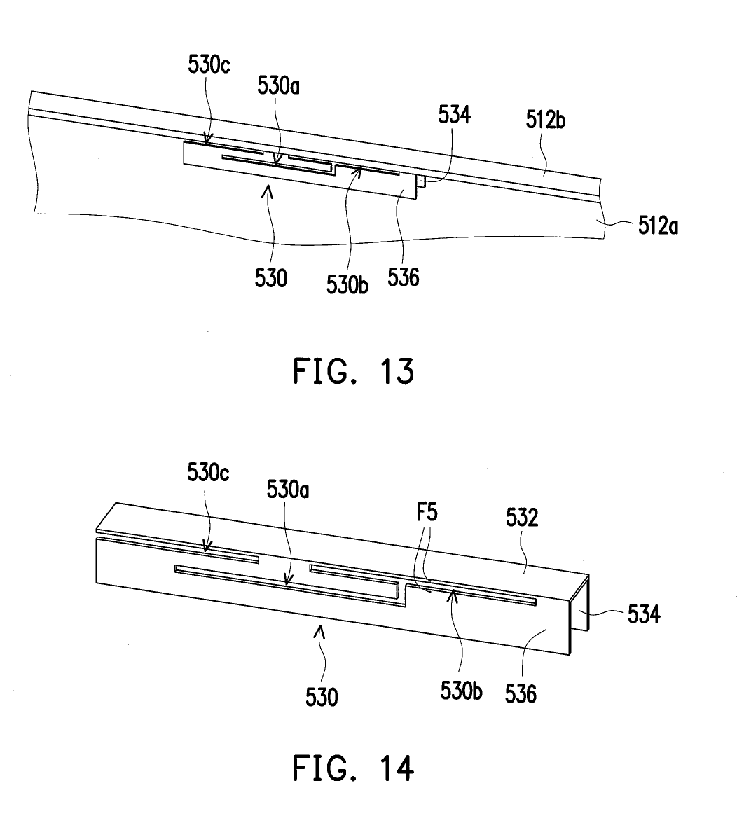

FIG. 13 is a partial three-dimensional diagram of an electronic device according to yet another embodiment of the invention and FIG. 14 is a three-dimensional diagram of the antenna unit of FIG. 13. Referring to FIGS. 13 and 14, the layout of a back cover 512a, a first side-wall 512b, a first conductor 532, a second conductor 534 and a third conductor 536 in the embodiment is similar to the layout of the back cover 412a, the first side-wall 412b, the first conductor 432, the second conductor 434 and the third conductor 436 in FIG. 9, which is omitted to describe. The major difference of the antenna unit 530 in the embodiment from the antenna unit 430 of FIG. 9 rests in that the first slot 430a, the second slot 430b, the third slot 430c and the feeding points F4 of the antenna unit 430 in FIG. 9 are formed at the first conductor 432, while a first slot 530a, a second slot 530b, a third slot 530c and feeding points F5 of the antenna unit 530 in the embodiment are formed at a third conductor 536. Since the first slot 530a, the second slot 530b and the third slot 530c do not face the first side-wall 512b, so that unlike the layout in FIG. 9 where the first side-wall 512b needs the notch S′ for exposing the first slot 430a, the second slot 430b and the third slot 430c. In the embodiment of FIGS. 13 and 14, the first slot 530a and the second slot 530b of the antenna unit 530 are formed at the third conductor 536 and do not face the back cover 512a. As a result, even when the material of the back cover 512a and the first side-wall 512b are metal and conductive, the interference of the back cover 512a and the first side-wall 512b on the signals received and transmitted by the antenna unit 530 through the first slot 530a and the second slot 530b can be reduced and the signal receiving/transmitting capacity of the antenna unit 530 is advanced.

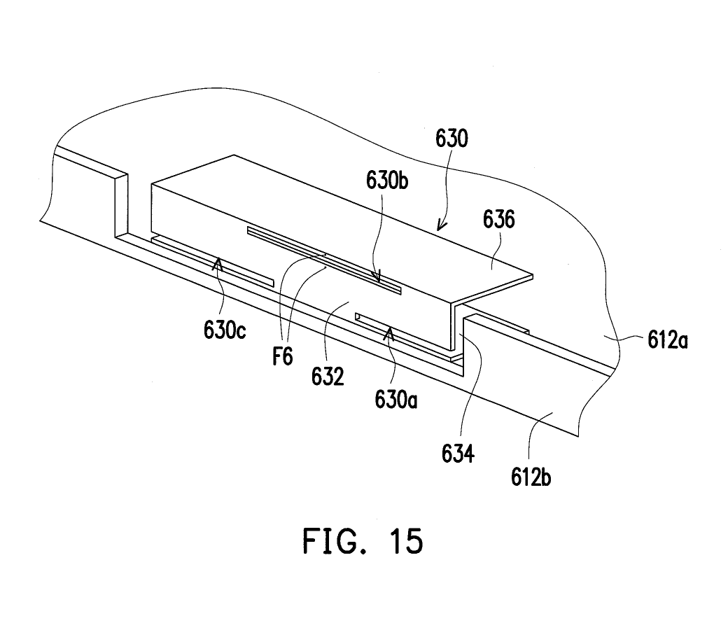

FIG. 15 is a partial three-dimensional diagram of an electronic device according to yet another embodiment of the invention. Referring to FIG. 15, in the embodiment, the layout of a back cover 612a, a first side-wall 612b, a first conductor 632, a second conductor 634, a third conductor 636 and feeding points F6 is similar to the layout of the back cover 412a, the first side-wall 412b, the first conductor 432, the second conductor 434, the third conductor 436 and the feeding points F4 in FIG. 9, which is omitted to describe. The major difference of the antenna unit 630 in the embodiment from the antenna unit 430 of FIG. 9 rests in that at least two of multiple slots of the antenna unit 630 (i.e., a first slot 630a, a second slot 630b and a third slot 630c as shown by FIG. 15) extend to the edge of the first conductor 632 to form a plurality of openings, in which the length of the first slot 630a is roughly equal to a quarter of the wavelength of a first resonant frequency and the length of the third slot 630c is roughly equal to a quarter of the wavelength of a second resonant frequency. The second slot 630b and the feeding points F6 are in charge of feeding-in the electromagnetic signals and coupling the electromagnetic energy to the first slot 630a and the third slot 630c to adjust the bandwidth of the antenna unit 630.

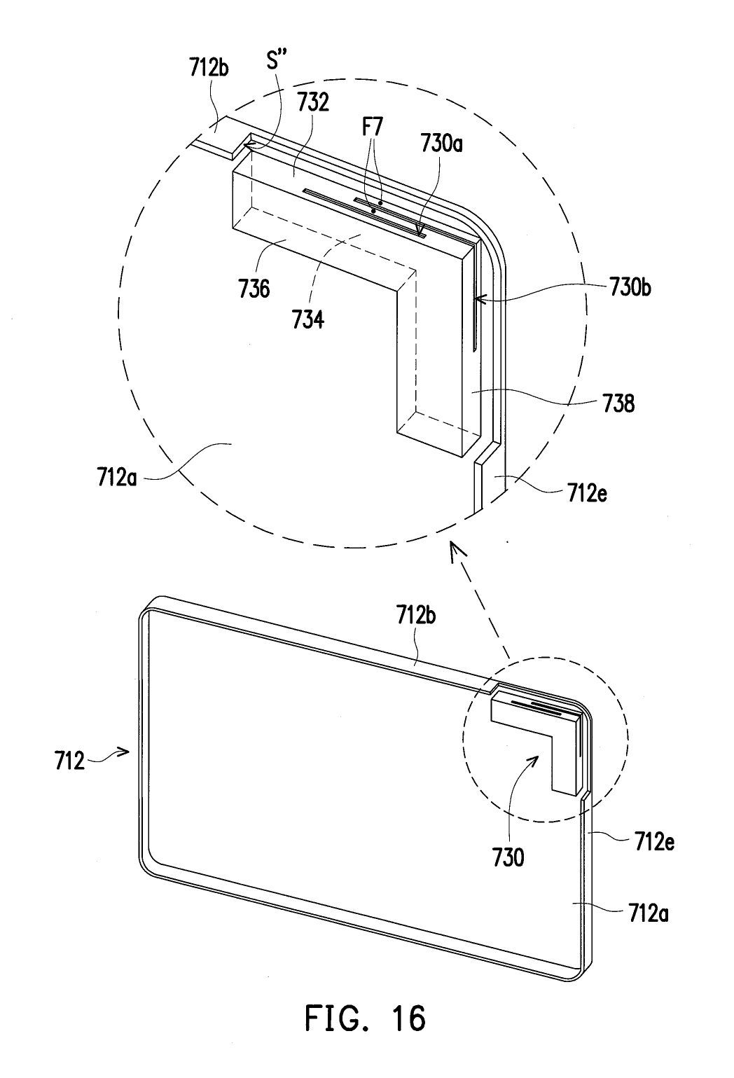

FIG. 16 is a three-dimensional diagram of some parts of an electronic device according to yet another embodiment of the invention. Referring to FIG. 16, in the embodiment, the layout of a back cover 712a, a first side-wall 712b, a first conductor 732, a second conductor 734, a third conductor 736 and feeding points F7 is similar to the layout of the back cover 112a, the first side-wall 112b, the first conductor 132, the second conductor 134, the third conductor 136 and the feeding points F1 in FIG. 3, which is omitted to describe. The major difference of the antenna unit 730 in the embodiment from the antenna unit 130 of FIG. 3 rests in that the antenna unit 730 further includes a forth conductor 738. The forth conductor 738 is connected to an end of the first conductor 732 and vertical to the first conductor 732. At least one of a first slot 730a and a second slot 730b (in FIG. 16, it is the second slot 730b) extends to the forth conductor 738 from the first conductor 732. A casing 712 further includes a second side-wall 712e. The second side-wall 712e is connected to an end of a first side-wall 712b and vertical to the first side-wall 712b, the forth conductor 738 is adjacent to the second side-wall 712e, a notch S″ extends to the second side-wall 712e from the first side-wall 712b to expose the antenna unit 730. In other words, the antenna unit 730 and the slot thereof in the embodiment extend to the place of the second side-wall 712e from the first side-wall 712b so as to increase the omnidirectional feature of the radiation pattern of the antenna unit 730 to further advance the signal receiving/transmitting capacity.

In summary, the antenna unit of the invention is disposed in the casing of the electronic device and adjacent to the first side-wall of the casing. The second conductor of the antenna unit faces the back cover of the casing so that the slots on the first conductor or the third conductor of the antenna unit do not face the back cover. Therefore, even the material of the back cover is metal and conductive, the signals received and transmitted by the antenna unit through the slots thereof are less affected by the interference of the back cover and the signal receiving/transmitting capacity of the antenna unit is advanced. In this way, there is no need to employ a non-metallic shell disposed on the back cover at a position corresponding to the antenna unit for avoiding the interference of the back cover on the antenna unit, which further enables the electronic device to have better appearance. In addition, since the antenna unit of the invention gains good signal receiving/transmitting capacity due to the above-mentioned layout, there is no need to form slots at the back cover for receiving/transmitting signals, which enables the back cover to have better appearance and reduces the process complexity of the back cover.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. An electronic device, comprising:
a body, having a casing, wherein the casing comprises a back cover and a first side-wall; and
an antenna unit, disposed in the casing and adjacent to the first side-wall, wherein the antenna unit has a plurality of slots and comprises:
a first conductor, facing the first side-wall;
a second conductor, bent connected to a side-edge of the first conductor to face the back cover and grounded to the back cover; and
a third conductor, bent connected to the other side-edge of the first conductor, wherein the slots are formed on at least one of the first conductor and the third conductor.

2. The electronic device as claimed in claim 1, wherein the first conductor, the second conductor and the third conductor form a U-shaped structure.

3. The electronic device as claimed in claim 1, wherein the casing further comprises a front frame, the third conductor faces the front frame, and the second conductor and the third conductor respectively lean against the back cover and the front frame to fix the antenna unit between the back cover and the front frame.

4. The electronic device as claimed in claim 1, wherein material of the back cover comprises metallic material.

5. The electronic device as claimed in claim 1, wherein the slots comprise a first slot and a second slot, a length of the first slot is equal to a half of the wavelength of a first resonant frequency and a length of the second slot is equal to a half of the wavelength of a second resonant frequency.

6. The electronic device as claimed in claim 5, wherein the first slot or the second slot extends to the third conductor from the first conductor.

7. The electronic device as claimed in claim 5, wherein the slots further comprise a third slot, the third slot extends to an edge of the first conductor or an edge of the third conductor to form an opening.

8. The electronic device as claimed in claim 5, wherein the antenna unit further comprises a fourth conductor, the fourth conductor is connected to an end of the first conductor and vertical to the first conductor, and the first slot or the second slot extends to the fourth conductor from the first conductor.

9. The electronic device as claimed in claim 8, wherein the casing further comprises a second side-wall, the second side-wall is connected to an end of the first side-wall and vertical to the first side-wall, and the fourth conductor is adjacent to the second side-wall.

10. The electronic device as claimed in claim 1, wherein at least two of the slots extend to an edge of the first conductor to form a plurality of openings.

11. The electronic device as claimed in claim 1, wherein the antenna unit has feeding points, the feeding points are disposed at the first conductor or the third conductor.

12. An antenna unit, having a plurality of slots and comprising:
a first conductor;
a second conductor, bent connected to a side-edge of the first conductor; and
a third conductor, bent connected to the other side-edge of the first conductor, wherein the slots are formed on at least one of the first conductor and the third conductor.

13. The antenna unit as claimed in claim 12, wherein the antenna unit is integrally formed.

14. The antenna unit as claimed in claim 12, wherein the first conductor, the second conductor and the third conductor form a U-shaped structure.

15. The antenna unit as claimed in claim 12, wherein the slots comprise a first slot and a second slot, a length of the first slot is equal to a half of the wavelength of a first resonant frequency and a length of the second slot is equal to a half of the wavelength of a second resonant frequency.

16. The antenna unit as claimed in claim 15, wherein the first slot or the second slot extends to the third conductor from the first conductor.

17. The antenna unit as claimed in claim 15, wherein the slots further comprise a third slot, the third slot extends to an edge of the first conductor or an edge of the third conductor to form an opening.

18. The antenna unit as claimed in claim 15, wherein the antenna unit further comprises a fourth conductor, the fourth conductor is connected to an end of the first conductor and vertical to the first conductor, and the first slot or the second slot extends to the fourth conductor from the first conductor.

19. The antenna unit as claimed in claim 12, wherein at least two of the slots extend to an edge of the first conductor to form a plurality of openings.

20. The antenna unit as claimed in claim 12, wherein the antenna unit has feeding points, the feeding points are disposed at the first conductor or the third conductor.
